(19) United States
(12) Patent Application Publication
(10) Pub. No.: US 2010/0276170 A1
(43) Pub. Date: Nov. 4, 2010

(54) PRESSURE RELEASING DEVICE FOR PNEUMATIC TOOLS

(75) Inventor: YI-KUAN LEE, Taichung County (TW)

Correspondence Address: PHILLIP LIU, 6980, WHITEOAK DRIVE, RICHMOND, BC, V7E 4Z9, CA

(73) Assignee: SAMSON POWER TOOL CO., LTD, Taichung County (TW)

(21) Appl. No.: 12/770,026

(22) Filed: Apr. 29, 2010

(30) Foreign Application Priority Data
May 1, 2009 (TW) 098207473

(51) Int. Cl. B25F 5/00

(52) U.S. Cl. 173/171

(57) ABSTRACT

A pressure releasing device includes an end cap connected to a rear end of a body of the pneumatic tool and includes an engaging area. A cylinder is located in a chamber in the body of the pneumatic tool and partially located in the engaging area. The engaging area includes an axle hole and output holes are located around the axle hole. A groove is defined in an inside of the engaging area and includes a tapered surface. The cylinder includes intake holes communicating the chamber in the body. Release holes are defined in the cylinder and communicate with the groove of the engaging area. Two seals are respectively engaged with a first recess and a second recess. The release holes are located between the first and second recesses. Multiple output holes are defined in the cylinder and communicate between an outside of the cylinder and the second recess.

### FIELD OF THE INVENTION

The present invention relates to a pneumatic tool, and more particularly, to a pressure releasing device for a pneumatic tool and the device includes a simple structure to efficiently release the pressurized air in the cylinder.

### BACKGROUND OF THE INVENTION

A conventional pneumatic tool such as a nail gun generally includes a body having a nozzle connected to a front end thereof and a valve unit is connected to an inside of the handle and which is activated by pulling the trigger. A magazine is connected to the body and provides nails into the body. A safety link is connected to a side of the body and located beside the nozzle. A spring is connected to the body and the safety link so that the nail is ejected by trigger only when both of the safety link and the trigger are pulled.

The pneumatic guns include two different designs for the cylinder in the body, the first one includes a piston rod movable in the cylinder so as to control the position of the piston which moves toward the nozzle to shoot the nails. This type of design has less resistance and the nails are not jammed or shot two nails at one shoot. However, the paths in the body are complicated and are difficult to be manufactured. The second one includes an upper path which provides pressurized air to control the movement of the piston. This type of design includes a simple structure but the resistance is significant and the nails are easily jammed or two nails may be shot at one shoot.

The present invention intends to provide a pressure releasing device for pneumatic tools wherein the air in the cylinder can be released when the piston rod moves backward and the paths in the body of the pneumatic tool are not complicated.

### SUMMARY OF THE INVENTION

The present invention relates to a pressure releasing device for a pneumatic and comprises an end cap connected to a rear end of a body of the pneumatic tool and the end cap has an engaging area which includes outlets and a groove is defined in an inside of the engaging area. A cylinder is located in a chamber in the body of the pneumatic tool and a first end of the cylinder is received in the engaging area. A piston rod connected with a piston is movable in the cylinder. The first end of the cylinder has release holes which communicate with the groove of the engaging area, and the release holes are located between a first recess and a second recess. A first seal and a second seal are respectively engaged with the first and second recesses. The first end of the cylinder has output holes which communicate between an outside of the cylinder and the second recess.

The first seal contacts against the engaging area to form a release path between the release holes, the first recess and the output holes so that air in the cylinder deforms the second seal in the second recess and escapes from the release path.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of a pneumatic tool with the pressure releasing device of the present invention;

FIG. 2 is a cross sectional view to show that the pneumatic tool is activated to shoot;

FIG. 3 is a cross sectional view to show that the pneumatic tool is not yet activated to shoot;

FIG. 4 is an enlarged view to show a portion of the pressure releasing device of the present invention;

FIG. 5 is an enlarged view to show that the piston in the cylinder begins to move toward the front end of the pneumatic tool;

FIG. 6 is an enlarged view to show that the piston in the cylinder moves to shoot;

FIG. 7 is an enlarged view to show the air flows when the piston in the cylinder moves backward, and

FIG. 8 is an enlarged view to show that the piston in the cylinder moves back to its original position as shown in FIG. 1.

### DETAILED DESCRIPTION OF THE PREFERRED EMBODIMENT

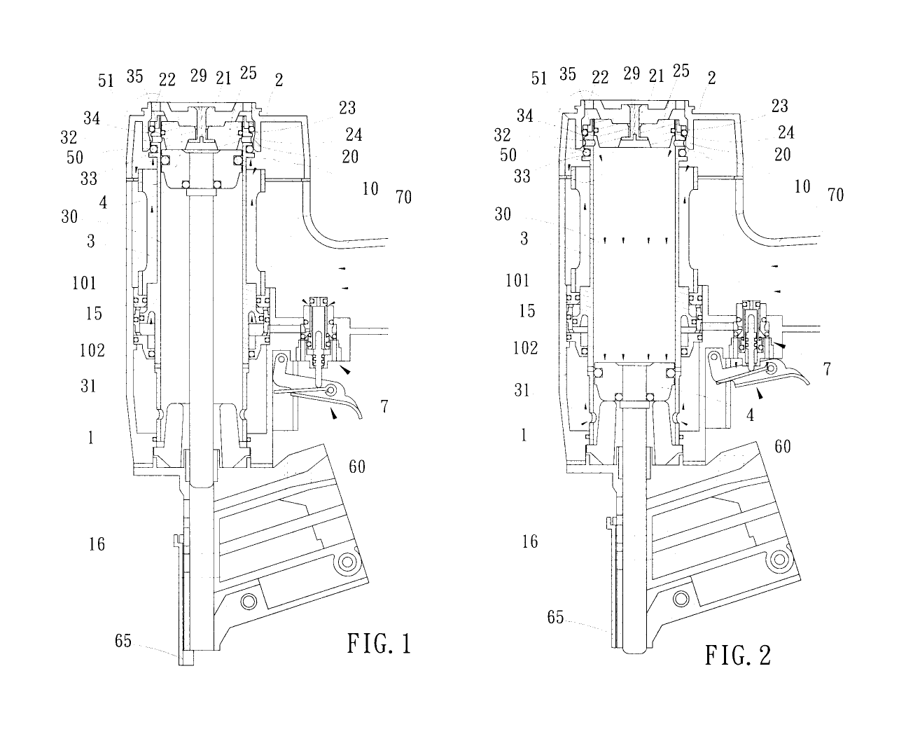

Referring to FIG. 1, the pneumatic tool such as a nailing gun generally comprises a body 1 having a nose at a front end of the body 1 and a handle connected to a rear end of the body 1. A trigger 60 is connected to the handle and cooperated with a valve 7 which includes a movable portion 70 which is movable to introduce pressurized air into the body 1 via the path in the handle. A safety link 65 is located on the outside of the body 1 and cooperated with the trigger 60. A magazine for receiving nails is connected to the body 1 so as to provide nails in the body 1.

The pressure releasing device for a pneumatic tool of the present invention comprises an end cap 2 connected to the rear end of the body 1 of the pneumatic tool and has an engaging area 20 with which a first end of a cylinder 3 is engaged. The end cap 2 includes an axle hole 21 located in the engaging area 20 and a buffering member 25 is connected to the engaging area 20 of the end cap 2 by a positioning member 29. Multiple outlets 22 are defined around the axle hole 21. A groove 23 is defined in an inside of the engaging area 20 and includes a tapered surface 24.

The cylinder 3 is located in a chamber 10 in the body 1 of the pneumatic tool and the first end of the cylinder 3 is engaged with the engaging area 20. The first end of the cylinder 3 is a section between the first recess 33 and an end surface of the first end of the cylinder 3. A piston rod connected with a piston 4 is movable in the cylinder 3. The first end of the cylinder 3 has release holes 32 which communicate with the groove 23 of the engaging area 20. The release holes 32 are located between a first recess 33 and a second recess 34. A first seal 50 and a second seal 51 are respectively engaged with the first and second recesses 33, 34. The first end of the cylinder 3 further has output holes 35 which communicate between an outside of the cylinder 3 and the second recess 34. The first seal 50 contacts against the inside of the engaging area 30 to control the air in the chamber 10 of the body 1 to release into the space 30 of the cylinder 3 via the release holes 32. Also, a release path is formed between the release holes 32, the groove 23 and the outlets 22 so that the pressure of the air in the cylinder 3 can deform the second seal 51 in the second recess 34 to determine the path that the air escapes from.

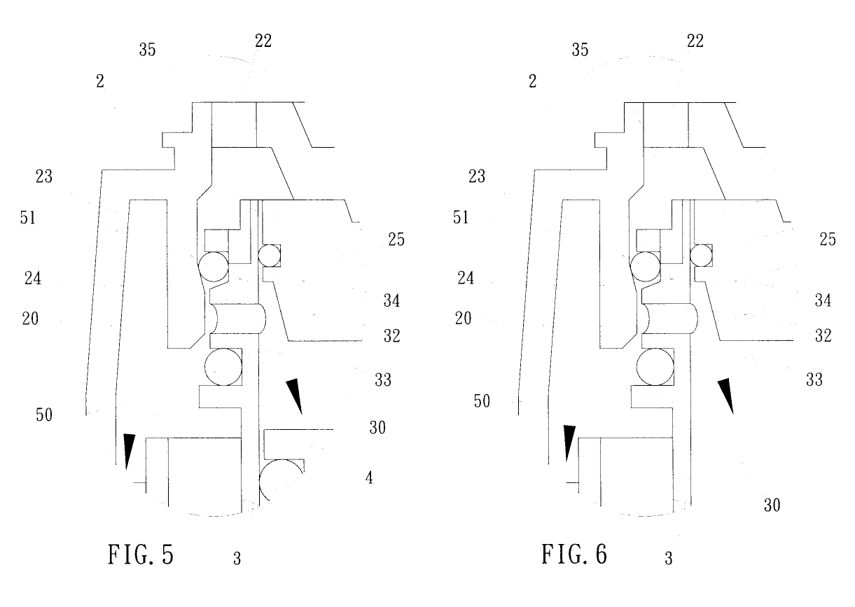

When the trigger 60 and the safety link 65 are both compressed, the piston 4 in the cylinder 3 begins to move a distance toward the second of the cylinder 3, wherein the second seal 51 in the second groove 34 is in contact with the tapered surface 24 located beneath the groove 23 by the force that the piston 3 moves toward the second end of the cylinder 3. The air in the cylinder 3 and the space above the piston 4 in the drawing cannot escape from the release holes 32. The air located outside of the cylinder 3 quickly fills the space above the piston 4 in FIGS. 5 and 6 such that the piston 4 is pushed toward the second end of the cylinder 3 to shoot the nail as shown in FIG. 2.

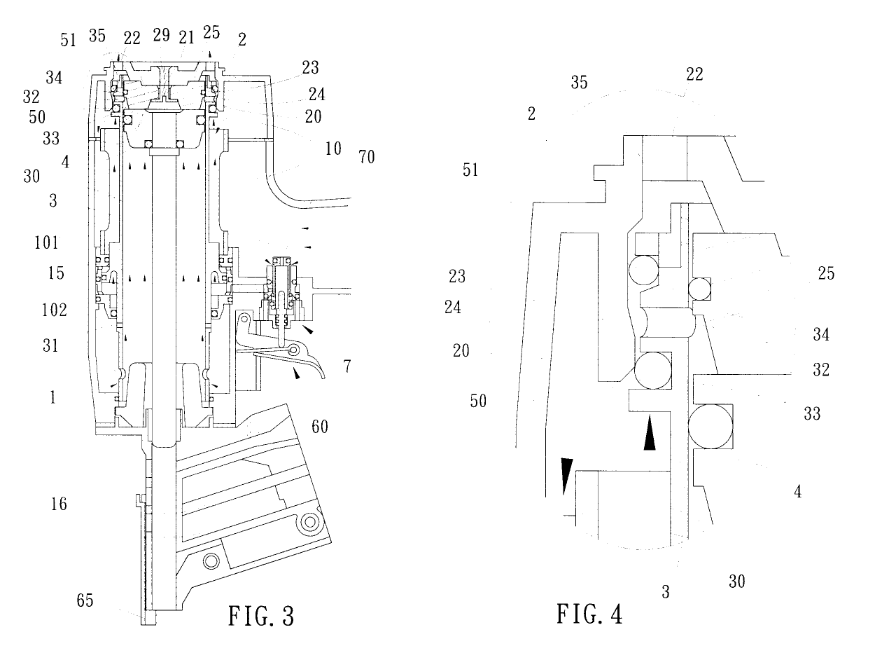

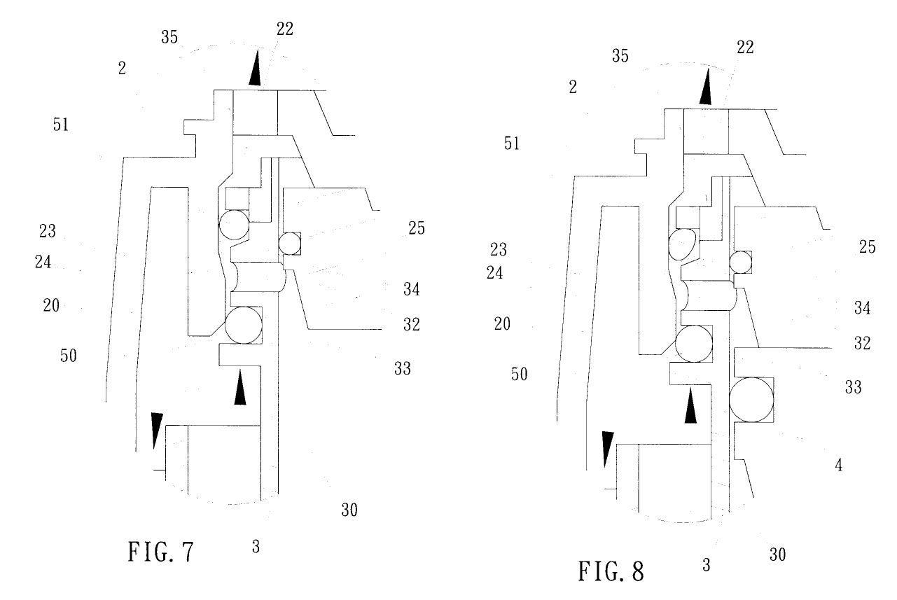

On the contrary, when the trigger 60 and the safety link 65 are not compressed, the movable portion 70 of the valve 7 changes its position and the piston 4 moves toward the first end of the cylinder 3 until the first seal 50 in the first recess 33 is snugly engaged with the inside of the engaging area 20 of the end cap 2 to stop the air in the chamber 10 of the body 1 from entering into the cylinder 3. In the meanwhile, the release holes 32 in the cylinder 3 communicate with the groove 23 in the engaging area 20, and a gap is defined between the second seal 51 in the second recess 34 of the cylinder 3 and the groove 23 of the engaging area 20. Therefore, a path is formed between the gap, the release holes 32 and the outlets 22. The air in the cylinder 3 can escape from the path and the pressure between the first end of the cylinder 3 and the piston 4 is minimized. The pressure in the second chamber 102 is larger than that in the space between the first end of the cylinder 3 and the piston 4, the piston 4 is moved toward the first end of the cylinder 3 as shown in FIG. 3. The air between the first end of the cylinder 3 and the piston 4 is released from the release holes 32 and enters the groove 23 in the engaging area 20. The air is released from the gap between the second seal 51 in the second recess 34 and the groove 23 in the end cap 2, and the outlets 22 as shown in FIG. 7. The second seal 51 in the second recess 34 is deformed by the force caused by the air flow so that the outer periphery of the second seal 51 expands outward and is snugly engaged with the inside of the groove 23. The inner periphery of the second seal 51 is located away from the position between the second recess 34 and the output holes 35, so that the air flows through the second recess 34, the output holes 35 and the outlets 22, and is released to the outside of the body 1 as shown in FIG. 8.

By the path that is formed by the second recess 34, the output holes 35 and the outlets 22, the air can efficiently be released. The releasing device includes a simple structure which is easily manufactured and the distance of the path is short so that the times of stroke of the piston 4 is increased. The air can quickly fill in the space between the piston 4 and the first end of the cylinder 3, this ensures that sufficient force is generated to shoot the nails.

While we have shown and described the embodiment in accordance with the present invention, it should be clear to those skilled in the art that further embodiments may be made without departing from the scope of the present invention.

What is claimed is:

1. A pressure releasing device for a pneumatic tool, comprising:
an end cap connected to a rear end of a body of the pneumatic tool and having an engaging area which includes outlets, a groove being defined in an inside of the engaging area;
a cylinder located in a chamber in the body of the pneumatic tool, a first end of the cylinder received in the engaging area, a piston rod connected with a piston being movable in the cylinder, the first end of the cylinder having release holes which communicate with the groove of the engaging area, the release holes located between a first recess and a second recess, a first seal and a second seal respectively engaged with the first and second recesses, the first end of the cylinder having output holes which communicate between an outside of the cylinder and the second recess, and
the first seal contacting against the engaging area to form a path between the release holes, the groove and the outlets so that air in the cylinder deforms the second seal in the second recess and escapes from the path.

2. The device as claimed in claim 1, wherein the first end of the cylinder is a section between the first recess and an end surface of the first end of the cylinder.

3. The device as claimed in claim 2, wherein the groove of the engaging area of the end cap includes a tapered surface which securely engages with the second seal in the second recess and seals a communication between the release holes and the groove of the engaging area.

4. The device as claimed in claim 3, wherein the end cap includes an axle hole and a buffering member is connected to the engaging area of the end cap by a positioning member.

5. The device as claimed in claim 4, wherein multiple output holes are defined in the end cap and located around the axle hole.

6. The device as claimed in claim 4, wherein a separation ring is located in the chamber of the body so as to position the cylinder in the chamber, the chamber is defined into a first chamber and a second chamber by the separation ring and the cylinder.

7. The device as claimed in claim 6, wherein the cylinder includes a space defined therein and a piston is movable in the space, intake holes are defined through a wall of the cylinder and communicate with the second chamber.
